(19) United States
(12) Patent Application Publication
(10) Pub. No.: US 2026/0323195 A1
(43) Pub. Date: Oct. 15, 2026

(54) WIRELESS HEADPHONES FOR CHILDREN WITH INTEGRATED PADDED HOUSING

(71) Applicants: Alex Gonzalez, Laguna Niguel, CA (US); Shayna Gonzalez, Laguna Niguel, CA (US)

(72) Inventors: Alex Gonzalez, Laguna Niguel, CA (US); Shayna Gonzalez, Laguna Niguel, CA (US)

(21) Appl. No.: 19/467,298

(22) Filed: Feb. 2, 2026

Related U.S. Application Data
(60) Provisional application No. 63/753,257, filed on Feb. 3, 2025.

(51) Int. Cl. H04R 1/02; H04R 1/06; H04R 1/10; H04R 1/1025

(52) U.S. Cl. CPC H04R 1/026; H04R 1/028; H04R 1/06; H04R 1/1025; H04R 1/1041; H04R 2420/07; H04R 2420/09

(57) ABSTRACT

A padded audio device for attachment to a child's car seat is described. The device is equipped with multiple speakers embodied as headphones which are contained within a comfortable padded housing. A logic controller coupled to a Bluetooth radio facilitate connection of the device to an audio source wirelessly. Parental controls ensure that a parent or guardian retains control of the audio levels, preventing hearing damage of the child. The device ensures only the child can hear the audio, providing a distraction-free driving experience for the parent/guardian driving the vehicle. A strap or similar mechanism enables attachment of the device to the car seat quickly and easily.

### CONTINUITY

This application is a non-provisional patent application of provisional patent application No. 63/753,257, filed on Feb. 3, 2025, and priority is claimed thereto.

### FIELD OF THE PRESENT INVENTION

The present invention relates to audio devices for children, and more specifically relates to a wireless Bluetooth™ headphone set specifically designed to provide a safe and individual audio experience for children that are integrated into padded housing. The housing is configured to be comfortably attached to a child's car seat headrest providing a frustration-free audio system for children to listen to their own personal movies, music and/or other audio devices.

### BACKGROUND OF THE PRESENT INVENTION

Conventionally, parents have employed audio devices to educate and entertain their children. Headphones and/or earphones are often used to convey the audio of a story, music, show, or movie to the ears of children and adults alike. However, parents are increasingly concerned about their children's exposure to noise through personal audio devices, including headphones and earbuds. A recent poll by C.S. Mott Children's Hospital revealed that 64% of parents reported their children aged 5-12 use headphones or earbuds. This widespread use among young children presents several challenges and concerns:

Hearing Health: It is known that prolonged exposure to loud noises through headphones can lead to hearing damage in children, whose auditory systems are still developing. As such, parents need a solution that limits volume levels to protect their children's hearing.

Safety and Comfort: Traditional headphones may not fit children properly, potentially causing discomfort or falling off easily. In such cases, a padded housing that securely fits around a child's head could address these issues.

Car Travel: Many parents report that their children use audio devices in the car. Unfortunately, there are not presently devices on the market that can easily be attached to a car seat headrest. Such a device would provide a safe and convenient solution for entertainment during travel.

Further, According to NHTSA data, approximately 8% of fatal crashes, 14% of injury crashes, and 13% of all reported vehicle traffic crashes in 2021 were considered “distraction-affected crashes,” meaning that they involved a distracted driver at the time of the accident. If devices were available which could entertain and isolate a child during a car ride without interfering with or distracting the driver, vehicle traffic crashes would be less likely. Such a device preferably provides a sound-free experience for the driver as such a device is only loud enough for the child to hear while remaining well below audio levels that could damage the hearing of the child.

Autism and Sensory Sensitivities: For children with autism or sensory processing issues, wireless headphones that are attached to the car seat as opposed to being directly on the child can help effectively provide a distraction free audio experience. A mounted integrated design could offer a sensory overload-free experience for these children by not creating a physical barrier for their entertainment. A padded, integrated design could offer a particularly soothing solution for these children.

Parental Control: Many parents struggle to limit their children's headphone use, with only 57% reporting they try to limit usage time. An integrated device with built-in volume and time limits could help address this concern.

Durability: Children's electronics often need to withstand rough handling. A padded, integrated design could offer better protection for the headphones.

Wireless Safety: Bluetooth headphones eliminate the risk of cord entanglement, which is especially important for younger children. Such a device preferably provides a wireless experience that eliminates wire safety concerns that most parents face with cable audio systems.

Thus, there is a need for a new headphone apparatus which addresses these needs by providing a safe, comfortable, and child-friendly audio solution that gives parents greater control over their children's listening habits, providing a distraction-free child sensory experience, all while offering safety to both driver/parent and child while driving by minimizing driver distraction.

Such a device is preferably configured to interface with (connect to, or otherwise attach herewith) a child's car seat or booster seat, and is preferably universally capable of attaching to the child's seat via at least one strap. Further, such a device preferably provides parental controls of the audio level that is unable to be changed by child users.

### SUMMARY OF THE INVENTION

The present invention is a wireless headphone apparatus and system, tailored for comfortable and seamless use by children while providing a distraction-free driving experience for adults.

This innovative wireless headphone system integrates high-quality audio technology into a comfortable, padded housing designed to attach to a car seat headrest. The elongated soft material houses two earphones positioned at opposite ends, ensuring optimal placement over the child's ears. A bendable wire backbone or frame is preferably present within the padded housing which enables the apparatus to be bent into an ideal position that corresponds to the shape of the children's car seat to which the present invention is installed.

The device features a built-in rechargeable battery accessible through a convenient charging panel, and volume controls are easily adjustable via a separate access point. Utilizing Bluetooth™ technology, these headphones connect wirelessly to various audio sources such as tablets or smartphones, eliminating potentially hazardous cords and enhancing freedom of movement.

Safety and versatility are at the forefront of the design of the present invention by addressing safety for drivers as well as safety for child use. The padded housing not only provides comfort for extended wear but also protects the internal components from external damage. Its unique ability to mount universally to a car seat headrest makes it an ideal companion for travel, while the wireless functionality and volume control features allow parents to manage their child's listening experience effectively as drivers/parents drive safely with uninterrupted car system audio sound. This all-in-one solution combines cutting edge audio technology with child-friendly design, offering a secure, comfortable, and convenient way to enjoy audio content during car travel, while keeping both child and driver/parent safety as the priority.

### BRIEF DESCRIPTION OF DRAWINGS OF THE PRESENT INVENTION

The present invention will be better understood with reference to the appended drawing sheets, wherein:

FIG. 1 shows a front view of the padded headphones of the present invention, detailing the access panel and padded housing.

FIG. 2 exhibits a view of the padded headphones of the present invention, shown installed to a child's car seat.

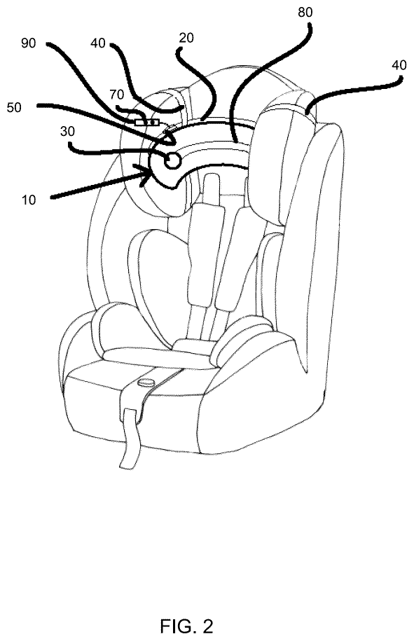

FIG. 3 depicts a flow chart detailing the process of use of the apparatus of the present invention.

FIG. 4 depicts a wire frame drawing of the padded housing of the present invention, depicting the placement of the speakers.

FIG. 5 exhibits a wire frame schematic of the internal wiring and remote of the apparatus of the present invention.

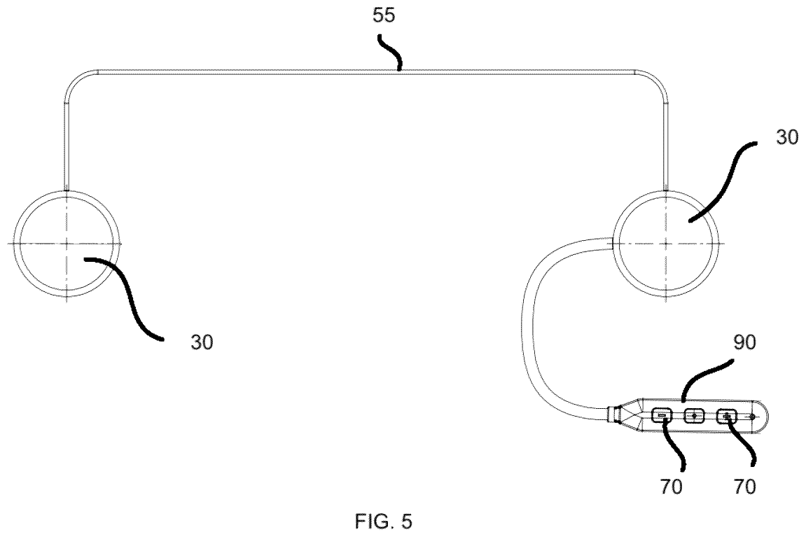

### DETAILED DESCRIPTION OF THE PRESENT INVENTION

The present invention comprises a set of wireless headphones (10) (also referred to as earphones, each of said earphones having one speaker) integrated into a padded housing (20). The housing (20) is designed to comfortably fit around a child's head or attach to a car seat headrest, providing both comfort and security.

The padded housing is made of a soft, child-friendly material that extends around the back of the child's head. This elongated soft material serves multiple purposes:
Comfort: The soft material ensures the device is comfortable for extended wear.
Protection: It protects the internal components of the headphones.
Positioning: It holds the earphones in place near the child's ears.

The padded housing (20) is designed with stuffing or foam, with each end of the housing containing one of the earphones. This design allows for a secure and comfortable universal fit to a car seat, regardless of the manufacturer. Further, the padded housing (20) is preferably equipped with an internal frame (80) or backbone which includes at least one flexible wire (25), configured to facilitate the bending of the apparatus to adhere to the shape and structure of the car seat to which the present invention is to be installed, as well as to provide a customized fit in accordance with the size of the head of the child.

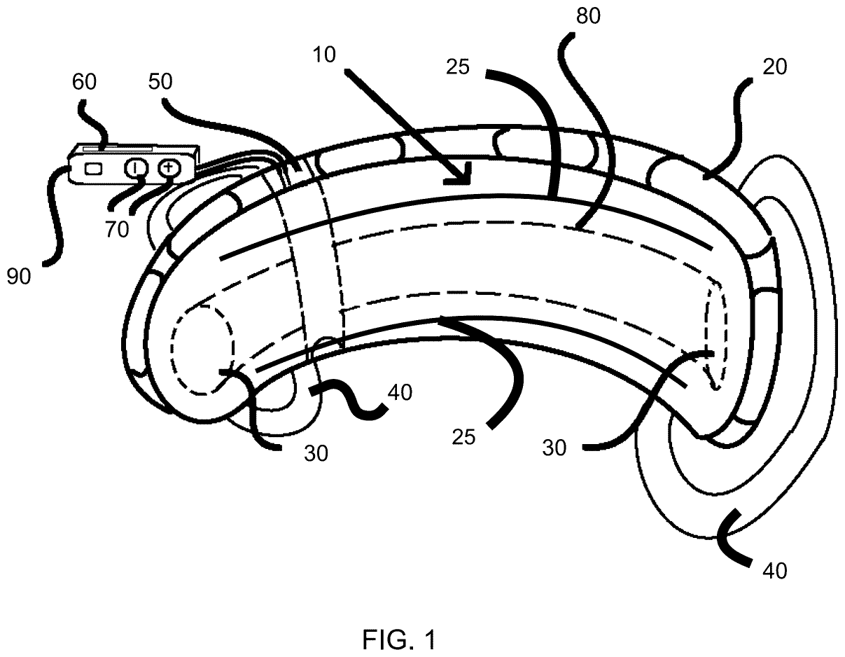

Each speaker (30) of the headphones or earphones is preferably held toward opposite ends of the elongated soft material of the padded housing (20) as shown in FIG. 1. This positioning ensures that when the padded housing (20) is attached to a car seat, the speakers (30) naturally align with the child's ears. The at least one flexible wire (25), present for support, is disposed inside of the padded housing (20) to enable the user to bend the portions of the padded housing (20) containing the speakers (30) towards the ears of the user, similar to a “C” or “U” shape.

The padded housing (20) is designed with a mechanism (40) to securely attach to a child's car seat headrest, ensuring universal car seat compatibility. This feature allows for easy use during car trips, providing entertainment for the child while keeping the device securely in place. The mechanism (40) is preferably at least one strap. The padded housing (20) is designed to obscure the internal circuitry and wires (55) of the present invention.

An access panel (50) is incorporated into the design of the present invention, accessible through an opening in the soft material of the housing (20). This panel (50) can be opened and closed to allow for charging of an internal battery (60) via a conventional Universal Serial Bus (USB) cable. The battery (60) is contained within the soft material of the padded housing (20). The access panel (50) also opens and closes to reveal volume controls (70) for the speakers (30) disposed on a control dongle (90) of the present invention. This feature allows for easy adjustment of sound levels without removing the device from the head of the child, or from the child's car seat.

The present invention utilizes wireless technology, preferably Bluetooth™, to connect to a sound source such as a tablet, smartphone, or other compatible device. This wireless connection eliminates the need for potentially hazardous cords or earbuds (which can present a choking hazard) and allows for greater freedom of movement for the child.

In summary, the present invention provides a safe, comfortable, personalized and convenient audio solution for both children and drivers/parents. Its unique design integrates the headphones into a padded housing which offers versatility during use and addresses common issues that both parents and children face during car travel such as comfort, security, safety and individual use. This device provides safety to not only the children during use but also the driver/parent by decreasing distraction and eliminating external audio distractions that most common travel headphones and/or entertainment devices create during car travel.

Internal components of the present invention preferably include, but are not limited to the following:
1. A Bluetooth Module: The heart of the wireless functionality is preferably a Bluetooth module, likely based on a chip like the Qualcomm™ CSR8645 Bluetooth audio IC1. This module is preferably configured to handle:
   Bluetooth 4.0 or later connectivity;
   Audio decoding (SBC, AAC, potentially aptX);
   Wireless pairing and connection management; and
   Operating in the 2.4 GHz ISM band.
2. A Logic Board/Microcontroller:
A small microcontroller is needed to:
   Manage power states;
   Handle user inputs (volume, play/pause, etc.);
   Control LED indicators; and
   Potentially implement noise cancellation algorithms.
3. An Audio Amplifier:
A low-power stereo amplifier like the PAM8403 class-D amplifier is ideally suitable to:
   Boost the audio signal from the Bluetooth module;
   Provide sufficient power for the speakers; and
   Operate efficiently to conserve battery life.
4. Speakers (30):
Two small speakers (likely 30-40mm drivers) are preferably integrated into the padded housing (20). These are:
   Positioned at each end of the padded housing (20);
   Likely using neodymium magnets for efficiency;
   Tuned for a child-friendly frequency response.
5. Battery (60): A rechargeable lithium-ion battery is preferably present to power the device. The battery (60) is preferably:
   Around 300-500 mAh capacity for several hours of audio playback; and
   Protected by a charging circuit (like a TP4056 module).
6. A Charging Port: A micro-USB or USB-C port is preferably present for charging the battery (60).
7. Control Buttons-Simple buttons or touch controls are preferably present for:
   Power on/off;
   Volume adjustment; and
   To Play/pause/skip tracks.
8. Light Emitting Diode (LED) Indicators-Small LEDs may be present on the present invention to show:
   Power status;
   Bluetooth connection status; and
   Charging status.
9. An Antenna: A small PCB antenna for Bluetooth connectivity.
10. Wiring and Connectors: Flexible wiring to connect components within the padded housing.

Optional components of alternate embodiments of the present invention include, but are not limited to: a microphone for calls or voice commands, Active Noise Cancellation (ANC) circuitry, and/or an NFC chip for easy pairing.

These components would be carefully arranged within the padded housing, with consideration for weight distribution, heat dissipation, and protection from impact or moisture. The design would prioritize safety and durability for child use, potentially using child-safe materials and avoiding small parts that could be choking hazards.

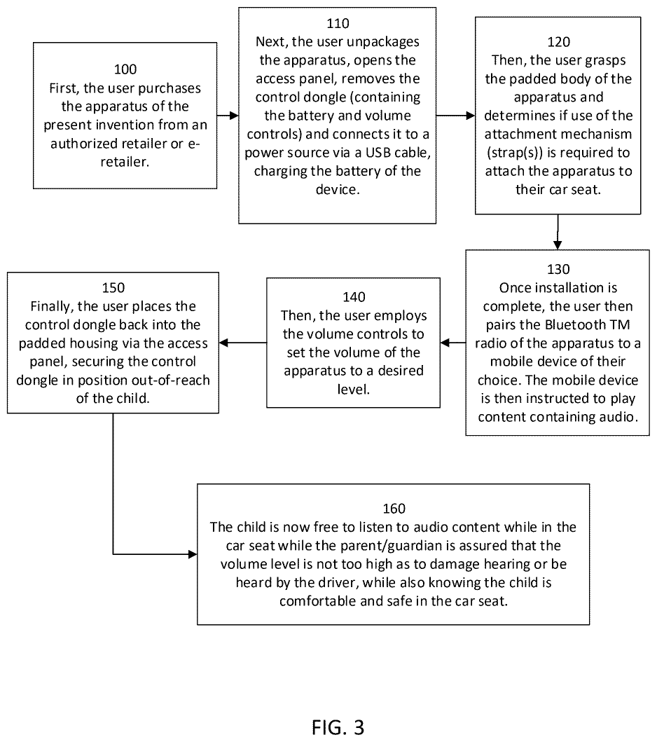

The method of installation and use of the system and apparatus of the present invention, as depicted in FIG. 3, is preferably as follows:
1. First, the user purchases the apparatus of the present invention from an authorized retailer or e-retailer. (100)
2. Next, the user unpackages the apparatus, opens the access panel, removes the control dongle (containing the battery and volume controls) and connects it to a power source via a USB cable, charging the battery of the device. (110)
3. Then, the user grasps the padded body of the apparatus and determines if use of the attachment mechanism (strap(s)) is required to attach the apparatus to their car seat. (120) Some children's car seats presently on the market exhibit a pass-through pocket at or near the head position, providing an easy location at which the center of the padded housing of the present invention may be disposed. Other car seats require use of the straps to ensure adequate retention of the apparatus to the car seat at the ideal height for the child to hear from the speakers of the apparatus.
4. Once installation is complete, the user then pairs the Bluetooth™ radio of the apparatus to a mobile device of their choice. The mobile device is then instructed to play content containing audio. (130) This may include podcasts, movies, television shows, YouTube™ content, music, audiobooks, or other content pertinent to children.
5. Then, the user employs the volume controls to set the volume of the apparatus to a desired level. (140)
6. Finally, the user places the control dongle back into the padded housing via the access panel, securing the control dongle in position out-of-reach of the child. (150)
7. The child is now free to listen to audio content while in the car seat while the parent/guardian is assured that the volume level is not too high as to damage hearing or be heard by the driver, while also knowing the child is comfortable and safe in the car seat. (160)

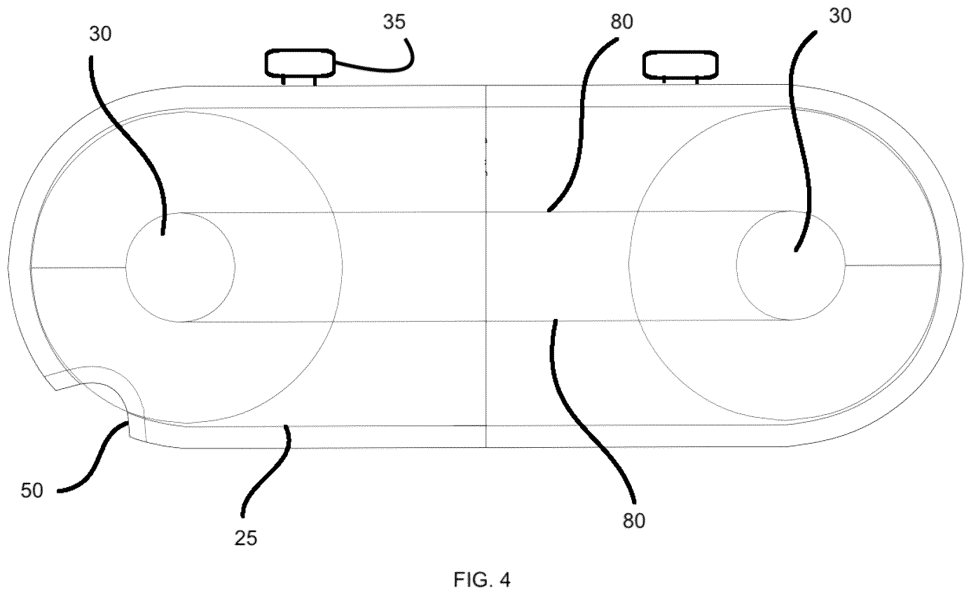

It should be noted that the preferred methods of manufacturing the present invention include, but are not limited to: molds, hand sewing, and 3D printing. Further, the present invention can be installed to, and is configured to fit within, all car seats, strollers, and airline seats. Further, the present invention can be draped around any headrest or head seat cushion. Preferred embodiments of the present invention are equipped with carabiners which are configured to attach to loops (35), shown in FIG. 4 disposed at a top of the apparatus to provide for the attachment of a strap. The strap ensures that the present invention may be wrapped around any headrest or head seat cushion, ensuring universal application of the present invention.

Future alternate embodiments of the present invention include an infant insert which exhibits a differently shaped head panel which is attached to the infant body cushion insert of car seats configured for use with infants. The head portion of the infant insert is configured to be easily removed for washing.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A wireless headphone apparatus comprising:
a padded housing made of soft material and configured to extend around a child's head;
two speakers positioned at opposite ends of the padded housing;
a rechargeable battery contained within the padded housing;
an access panel incorporated into the padded housing and accessible through an opening in the soft material;
volume controls accessible via the access panel;
a Bluetooth module configured to wirelessly connect to an audio source; and
an attachment mechanism configured to attach the padded housing to a child's car seat headrest.

2. The wireless headphone apparatus of claim 1, wherein the attachment mechanism comprises at least one strap.

3. The wireless headphone apparatus of claim 1, wherein the padded housing comprises an internal frame composed of at least one flexible wire configured to facilitate bending of the apparatus to conform to a shape of the car seat.

4. The wireless headphone apparatus of claim 1, wherein the access panel is configured to open and close to allow charging of the rechargeable battery via a Universal Serial Bus cable.

5. The wireless headphone apparatus of claim 1, wherein the volume controls are disposed on a control dongle accessible through the access panel.

6. The wireless headphone apparatus of claim 5, wherein the control dongle is configured to be secured within the padded housing out of reach of a child.

7. The wireless headphone apparatus of claim 1, wherein the Bluetooth module is configured to operate using Bluetooth connectivity.

8. The wireless headphone apparatus of claim 1, wherein the speakers comprise 30-40 mm drivers positioned to naturally align with a child's ears when the padded housing is attached to the car seat.

9. The wireless headphone apparatus of claim 1, wherein the rechargeable battery is configured to facilitate multiple hours of audio playback.

10. The wireless headphone apparatus of claim 1, further comprising an audio amplifier configured to boost an audio signal from the Bluetooth module to provide sufficient power for the speakers.

11. A wireless audio system for children comprising:
an elongated padded housing made of soft child-friendly material;
two earphones integrated into the padded housing, each earphone positioned at opposite ends of the elongated padded housing;
a wireless communication module configured to connect to audio sources;
a rechargeable power source contained within the padded housing;
parental control features accessible through a removable access panel; and
a universal attachment system configured to secure the padded housing to various car seat headrests.

12. The wireless audio system of claim 11, wherein the padded housing is designed with stuffing or foam to provide comfort and protection for internal components.

13. The wireless audio system of claim 11, wherein the wireless communication module utilizes Bluetooth technology to eliminate potentially hazardous cords.

14. The wireless audio system of claim 11, wherein the parental control features include volume controls that cannot be changed by child users.

15. The wireless audio system of claim 11, wherein the universal attachment system is configured to provide compatibility regardless of car seat manufacturer.

16. The wireless audio system of claim 11, further comprising LED indicators configured to show power status, Bluetooth connection status, and charging status.

17. The wireless audio system of claim 11, wherein the padded housing is configured to obscure internal circuitry and wires.

18. A method of providing safe audio entertainment for children during car travel comprising:
providing a wireless headphone apparatus with a padded housing containing two speakers at opposite ends;
attaching the padded housing to a child's car seat headrest using an attachment mechanism;
pairing a Bluetooth radio of the apparatus to a mobile device;
setting volume controls to a desired level through an access panel; and
securing the volume controls within the padded housing out of reach of the child.

19. The method of claim 18, further comprising charging a rechargeable battery within the padded housing via a USB cable before use.

20. The method of claim 18, wherein the step of attaching comprises using at least one strap to ensure adequate retention of the apparatus to the car seat at an ideal height for the child to hear from the speakers.
